(19) United States
(12) Patent Application Publication
(10) Pub. No.: US 2006/0218008 A1
(43) Pub. Date: Sep. 28, 2006

(54) Comprehensive social program data analysis

(76) Inventor: Darlene Rae Cole, San Diego, CA (US)

Correspondence Address: Harry V. McGahey, Jr., 1532 Sixth Ave., San Diego, CA, 92101, US

(21) Appl. No.: 11/388,077

(22) Filed: Mar. 23, 2006

Related U.S. Application Data
(60) Provisional application No. 60/665,440, filed on Mar. 25, 2005.

(51) Int. Cl. G06Q 10/00; G06Q 40/00; G06Q 50/00

(52) U.S. Cl. 705/2; 705/4

(57) ABSTRACT

A method for administering, monitoring and evaluating a social program to determine whether or not it has been effective for its intended design by allowing the users to easily compare the effectiveness of the proposed outcome indicators being measured with regard to the activities being tracked.

### PRIORITY CLAIM

This patent claims priority based upon the filing of U.S. Provisional Patent Application Ser. No. 60/665,440 on Mar. 25, 2005.

### FEDERAL FUNDS NOTICE

No Federal Funds were used in the development of this Invention.

### INTRODUCTION

This software computer application concerns an easy to use and efficient apparatus and method for administering and evaluating the effectiveness of social programs in accomplishing the goals of each such particular program.

### DEFINITIONS

In this application, the word “Social program” is defined as any educational, charitable, social, governmental, training, medical, profit oriented business, non-profit oriented business, or other human resource based operation or endeavor designed to improve the lives or the physical performance output of the participants in some manner or degree. The apparatus or method can be used with any such social service program to administer it and enhance its effectiveness.

The words “proposed outcome indicators” refer to the measurable observable results of a particular social program being administered such as grade point average, number of births per mother, number of days of work or school missed, income for a specific period, medical expenses incurred for a particular period, or any quantifiable or measurable output of an individual etc.

The word “Goals” refers to the result which is expected or intended to be reached or observed for a particular social program which is utilizing this invention.

### BACKGROUND

Attempts to improve the lives of various groups and subgroups of persons using administered programs in the medical, educational, charitable, training, service, and other human resource based fields in the United States is a multi-billion dollar industry. However there is currently no easy-to-use and efficient method for evaluating the effectiveness of such programs in accomplishing the goals for which the programs are designed. Often times programs must be administered by organizations (e.g., charitable organizations, hospitals, municipalities, colleges and schools) with a limited amount of trained staff and money available to administer, monitor and evaluate the effectiveness of these programs.

Administering such human resource intensive programs and tracking recipient participation and outcomes is extremely complex and difficult. There are often so many variables and activities which can influence the desired outcomes of these programs that it is difficult or impossible to tell whether the program being administered was effective in improving the lives of the participants in the area or modality for which the program was designed. Often times it is therefore impossible to tell whether the social program itself accomplished the desired outcome, or some other unrelated variable was responsible for the differences between persons in the social program and persons outside the program.

In addition, persons, governments or private entities supplying the funding for these programs often require detailed regular reports which are difficult to compile under current technology.

This application discloses an apparatus and method which solves the above problems. It is easy to use and allows a program administrator to:

1) Be more efficient in administering the program;

2) Keep better track of what activities the participants are engaged in or what benefits they are receiving;

3) Be more effective in monitoring the current status of each participant;

4) Be able to effectively evaluate whether or not the program was effective in achieving its desired goals;

5) Determine which activities and benefits received were most effective in reaching the goals of the program for various classes and sub-classes of participants.

6) Prepare detailed required reports on the activities and benefits provided to the participants for various classes and sub-classes of participants in the program.

This invention also has the unique ability to evaluate the effectiveness of a particular program using such statistical inference analysis techniques as correlation, t-test, chi-square, and other statistical methods expressed both in a table format and in a graphing format. This allows the users of this invention to very effectively examine the effects of individual program activities and elements on program goals. It also allows them to accurately determine whether or not a particular program has been effective overall in reaching its goals.

There are currently very limited solutions to these problems of participant service, monitoring and evaluation of human resource intensive social programs. There are some computer based monitoring systems available but none incorporate such detailed analysis capabilities using inferential statistics as effectively and in an as easy to use fashion as the invention disclosed in this application.

The current invention will meet a need which is currently not being met. It provides a cost effective, inexpensive method to administer, monitor and analyze the effectiveness of participant social, service, activity and training programs, irrespective of whether they are focused on charitable, medical, educational, training, business or social goals.

Institutions with limited funding will find this invention very useful as a solution to their staff and funding limitation problems when it comes to monitoring and impact evaluation of such social, service, activity and training programs.

### SPECIFICATION OF THE INVENTION

The invention described herein describes a new method and apparatus for monitoring and evaluating social programs, including service, activity and training programs. It can be used even by administrators with limited research and data management experience, and does not require any significant prior computer use experience.

The method and apparatus are comprised of a computer system which keeps track of all program recipient information, activities and selected outcome data. After the recipient information and selected outcome indicators have been entered into the system, the system is then used to evaluate the effectiveness of individual program activities or elements using inferential statistical analysis to determine whether or not the participants in the program improved in line with the goals of the program.

More specifically, the program can be described in two basic ways: 1. A method for evaluating the usefulness of a social program comprising:

a) The administrators of the program gather up pre-program information concerning indicators relating to program outcomes and goals for a population of program service, activity or training recipients. The administrators of the program select what activities it is important to measure and obtain participant specific information related to these activities from program participants

b) Next the administrators of the program obtain information concerning similar indicators for a control population.

c) The administrators then store the control and pre-participation indicator information by an electronic means such as an electronic personal computer so that it can be analyzed using inferential statistical analysis methods.

d) The administrators then implement the social, service, activity or training program.

e) During the implementation phase of the program, the administrator obtains ongoing, intermediate, and post program information concerning the proposed outcome indicators for the same populations of recipients of the service, activity or training program.

f) The administrator also obtains and records similar information concerning outcome indicators for a control population not served by the social, service, activity or training program.

g) After the desired interval of time, the administrator compares the pre-and post-program data of the program recipients and the control group according to an inferential statistics method which calculates the statistical significance of the differences between the program recipients and the control group as appropriate. Various methods for calculating inferential statistics results using methods such as standard deviation, mean, t-test, chi square etc. may be used.

h) The administrator then selects displayable lists, tables, graphs and results summaries that have been calculated by the statistical inference method for values, resulting outcomes, any covariance of treatment differences and outcome differences. For example, grade point averages, days missed from work or school, medical costs incurred, demographic data, dosage of treatment, duration and frequency of participation in program services and activities, etc. could be used; and

i) The administrator or other decision makers then make a decision based upon the results of the inferential statistics method as to whether or not the program or program element has been effective for its intended use based on the displayed statistical findings. These decisions makers can then modify the program as required to make it more effective, increase funding for various activities shown by the invention to be effective, decrease ineffective activities etc. in order to fine tune the program's cost effectiveness for the future. The other way to characterize the invention is as an apparatus for analyzing the effectiveness and usefulness of participant service, activity or training programs comprising:

a) a computer processor means comprising a personal computer including a CPU, or a network server, for processing data;

b) storage means comprising a computer hard drive or a network server for storing data on a storage medium;

c) an electronic storage means to obtain and store control group indicator information;

d) an electronic storage means to obtain and store pre-participation indicator information for program participants;

e) first means comprising an arithmetic circuit configured to prepare the computer hard drive or a network server to store selected data for initializing the storage medium;

f) second means comprising an arithmetic logic circuit configured to retrieve information from a specific file, calculate incremental increases or decreases based on specific outcome score, allocate the results on a percentage or unit increase or decrease basis and as retrievable data value points, and store the output in a separate file for processing data regarding whether or not there has been a statistically significant improvement in program effectiveness and related outcome data during the time period measured for that file.

g) third means comprising an arithmetic logic circuit configured to retrieve information from a specific number of files, calculate using inferential statistics analysis whether or not there has been an improvement in the outcome indicators for the population of specified files during the time period measured for those files.

More specifically, the actual comparison of the data and the presentation of the output in an easy to interpret display is accomplished by this invention, whether as a method or an apparatus as follows:

a) The data are input into the system either manually, or electronically after they are formatted to fit the system requirements;

b) The user selects a particular analysis (e.g., chi-square, correlation, etc.) and particular variables desired (e.g., hours of services, grade point average, by gender, etc.);

c) Via computer programming, the data are computed based on preset statistical formulas; a probability level is also calculated;

d) The probability level is then compared with a set of predefined statistical parameters. If the probability level meets or surpasses the threshold, the probability is identified as representing a statistically significant effect - and a sentence is displayed on the computer screen informing the user that the variables selected show the intended relationship (e.g., “There is a significant difference in Change in GPA between program students and control group students”). Likewise, if the probability level does not meet the threshold, a sentence is displayed that the variables selected do not appear to be statistically related;

e) Simultaneously, computer programming sets parameters for presenting a graphic display of the resulting outcome scores/data. Each type of analysis is programmed to display an appropriate type of graph corresponding the type of data (e.g., categorical, continuous) used in the analysis. The programming predetermines the visual presentation of the graph, but the actual level of the graph columns/bars are determined by the computed scores for that particular analysis.

Although the present invention has been described in considerable detail with reference to its use in the fields of education, social, service, activity and training programs, other versions are possible. For example:

The invention could be used in healthcare programs that provide a treatment with the goal of altering the physical or mental health of the participants in a specified manner. Alternatively, public safety programs that provide a treatment with the goal of altering the social/criminal behavior of the participants in a specified manner can also be administered, monitored and evaluated using this method and apparatus.

### BRIEF DESCRIPTION OF THE DRAWINGS

FIG. 1 illustrates an overview of the method aspect of the invention.

### DETAILED DESCRIPTION OF THE DRAWINGS

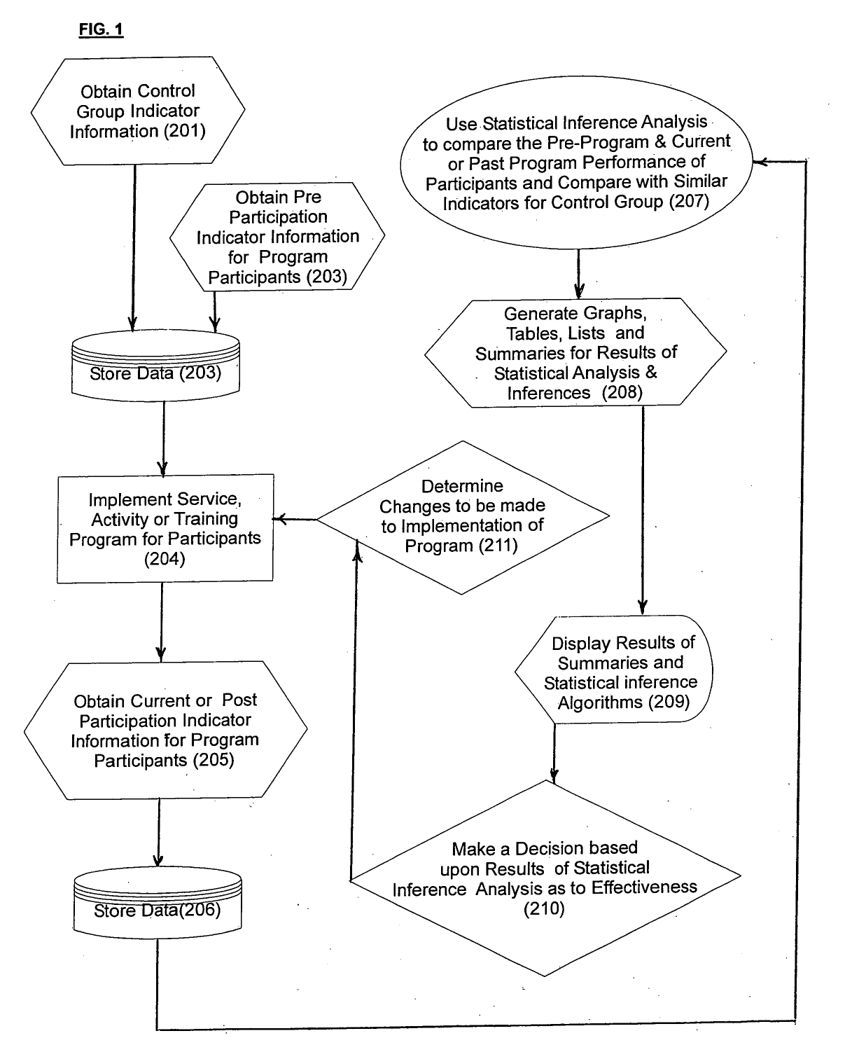

In FIG. 1 the initial procedure of obtaining control group indicator information (201) and pre-participation indicators for program participants (202) is shown. This type of information may be entered manually or collected by electronic means, but the results of both methods of collection should be stored electronically in a way that the results can be analyzed using inferential statistical analysis methods.

This data is then stored electronically (203) for future access. The service, activity, training or program for the participants is then implemented (204). After the program participants have participated in the program for a period of time, current participant indicator information for program participants is obtained (205) and then stored electronically (206). (The last data obtained as final participant indicator information at the end of the program is denominated as “Post Participant Indicator Information”.)

Statistical Inference Analysis methods are then used to compare the pre-program and current or past program performance of participants with similar indicators for the control group (207)

The results of the Statistical Inference Analysis methods are then used to generate graphs, tables, lists and summaries of the results of the analysis (208). These results are then displayed (209) for the supervisors of the program who then make decisions (210) based upon the results of the statistical inference analysis as to the effectiveness of the programs, and who then determine what changes should be made to the implementation of the program in the future (211).

At the end of the program, the final Post-Participant Indicator Information can be utilized with the inferential statistical analysis methods to determine whether or not the program has been effective in achieving its desired goals.

I claim:

1. A method, in a data processing system, for administering and evaluating the usefulness of a social program, said method comprising:
a) obtaining pre-program information concerning indicators relating to program outcomes and goals for a population of program service, activity or training recipients;
b) obtaining information concerning similar indicators for a control population;
c) storing the control and pre-participation indicator information by an electronic means so that it can be analyzed using inferential statistical analysis methods;
d) implementing the social program;
e) obtaining ongoing, intermediate, and post program information concerning the proposed outcome indicators for the same populations of recipients of the social program;
f) obtaining similar information concerning outcome indicators for a control population not served by the social program;
g) comparing the pre-program and post-program data of the social program recipients and the control group according to an inferential statistics method which calculates statistical significance of the differences between the social program recipients and the control group as appropriate;
h) selecting displayable lists, tables, graphs and results summaries that have been calculated by the statistical inference method for values, resulting outcomes, covariance of treatment differences and outcome differences;
i) making a decision based upon the results of the inferential statistics method as to whether or not the social program or social program element has been effective for its intended use based on the displayed statistical findings;
j) implementing any changes to the implementation of the social program shown to be desirable based upon the comparisons of the control group and the pre-and post-participant outcome indicators;

2. A data processing system for administering and evaluating the usefulness of a social program comprising:
a) a computer processor means comprising a personal computer including a CPU, or a network server, for processing data;
b) storage means comprising a computer hard drive or a network server for storing data on a storage medium;
c) an electronic storage means to obtain and store control group indicator information;
d) an electronic storage means to obtain and store pre-participation indicator information for social program participants;
e) first means comprising an arithmetic circuit configured to prepare the computer hard drive or a network server to store selected data for initializing the storage medium;
f) second means comprising an arithmetic logic circuit configured to retrieve information from a specific file, calculate incremental increases or decreases based on specific outcome score, allocate the results on a percentage or unit increase or decrease basis and as retrievable data value points, and store the output in a separate file for processing data regarding whether or not there has been a statistically significant improvement in social program effectiveness and related outcome data during the time period measured for that file.
g) third means comprising an arithmetic logic circuit configured to retrieve information from a specific number of files, calculate using inferential statistics analysis whether or not there has been an improvement in the outcome indicators for the population of specified files during the time period measured for those files.

3. The method of claim 1 wherein the data is input into the system electronically after it is formatted to fit the system requirements.

4. The apparatus of claim 2 wherein the data is input into the system electronically after it is formatted to fit the system requirements.

5. The method of claim 1 wherein the user selects the particular statistical analysis and particular variables desired to be compared, the data are compared, the statistical analysis is computed based on a preset statistical formula, and a probability level is also calculated.

6. The apparatus of claim 2 wherein the user selects the particular statistical analysis and particular variables desired to be compared, the data are compared, the statistical analysis is computed based on a preset statistical formula, and a probability level is also calculated.

7. The method of claim 5 wherein if the probability level meets or surpasses a pre-set threshold, the probability is identified as representing a statistically significant effect and a sentence is displayed on the computer screen informing the user that the variables selected show the intended relationship, whereas if the probability level does not meet the threshold, a sentence is displayed informing the user that the variables selected do not appear to be statistically related and do not show the intended relationship.

8. The apparatus of claim 6 wherein if the probability level meets or surpasses a pre-set threshold, the probability is identified as representing a statistically significant effect and a sentence is displayed on the computer screen informing the user that the variables selected show the intended relationship, whereas if the probability level does not meet the threshold, a sentence is displayed informing the user that the variables selected do not appear to be statistically related and do not show the intended relationship.

9. The method of claim 7 wherein the computer programming sets parameters for presenting a graphic display of the resulting outcome data, each type of analysis is programmed to display an appropriate type of graph corresponding the type of data used in the analysis, and the actual level of the graph columns displayed are determined by the computed data for that particular analysis.

10. The apparatus of claim 8 wherein the computer programming sets parameters for presenting a graphic display of the resulting outcome data, each type of analysis is programmed to display an appropriate type of graph corresponding the type of data used in the analysis, and the actual level of the graph columns displayed are determined by the computed data for that particular analysis.
